(19) United States
(12) Patent Application Publication
(10) Pub. No.: US 2015/0058200 A1
(43) Pub. Date: Feb. 26, 2015

(54) ARCHITECTURE OF SIMPLIFIED HARDWARE REQUIREMENTS FOR BANK CARD PAYMENT TRANSACTIONS IN A LARGE GROUP OF CLIENTS, TRANSACTION TERMINAL UNIT, EXTENDED FUNCTION SIM CARD, AND METHODS FOR INDIVIDUALISATION AND PERFORMING TRANSACTION

(71) Applicants: Balazs INOTAY, Budaors (HU); Gabor Parragh, Budajeno (HU); Bank Hadik Barkoczy, Erd (HU); Ferenc Kokovai, Budapest (HU); Laszlo Fuko, Taktaharkany (HU); Andras Kapitany, Budapest (HU); Peter Karpati, Budapest (HU); Gabor Lipcsei, Szolnok (HU)

(72) Inventors: Balazs INOTAY, Budaors (HU); Gabor Parragh, Budajeno (HU); Bank Hadik Barkoczy, Erd (HU); Ferenc Kokovai, Budapest (HU); Laszlo Fuko, Taktaharkany (HU); Andras Kapitany, Budapest (HU); Peter Karpati, Budapest (HU); Gabor Lipcsei, Szolnok (HU)

(21) Appl. No.: 14/451,634

(22) Filed: Aug. 5, 2014

Related U.S. Application Data
(62) Division of application No. 10/503,803, filed on Mar. 30, 2005.

(30) Foreign Application Priority Data
Feb. 7, 2002 (HU) P 0200463

(51) Int. Cl. G06Q 20/32

(52) U.S. Cl. CPC G06Q 20/3229; G06Q 20/3255
USPC 705/39

(57) ABSTRACT

Architecture of simplified hardware requirements for bank card payment transactions in a large group of clients, in which each client have an extended function SIM card containing payment utility and regular bank card identification information. A mobil pay center (4) is connecting to the client and the service provider (2) of the actual transaction through a bidirectional cryptographic interface and a communication channel of the first type, and is connecting to one or more bank card authorisation center (11) of the actual transaction through a bidirectional cryptographic interface and a communication channel of the second type. The mobil pay center (4) is comprising at least one virtual POS terminal (5) for each service provider (2). The virtual POS terminal (5) handle authorisation messages received through communication channel of the second type.

The present invention relates to an architecture of simplified hardware requirements for bank card payment transactions in a large group of clients, in which clients and service providers exist, the clients keep a bank account at one or more issuing banks which are authorized to issue bank cards, and have a mobile bank card provided with a customary bank card identification information, a GSM mobile phone, and a valid SIM card for enabling access of the GSM services, the service providers keep a bank account at one or more acquiring banks, and have a unit with a function of a transaction terminal, and a device adapted for receiving system messages.

The invention further relates to a transaction terminal unit adapted for data verification of a bank card and/or management of an authorization message received through a communication channel, the transaction terminal is installed in an architecture of simplified hardware requirements for financial transactions in a large group of clients, in which clients and service providers exist, the clients keep a bank account at one or more issuing banks which are authorized to issue bank cards, and have a mobile bank card provided with a customary bank card identification information (or some other mobile payment instrument to be described later), a GSM mobile phone, and a valid SIM card for enabling access of the GSM services, the service providers keep a bank account at one or more acquiring banks, and have a unit with a function of a transaction terminal, and a device adapted for receiving system messages.

The invention further relates to an extended function SIM card for a GSM mobile phone of a subscriber, which in addition to a memory required for functions to make GSM services available, comprises a separate second memory for storing additional data, and a control unit (CPU) adapted for at least performing logical operations.

The invention further relates to a method for individualization or as we further call personalization of an extended function SIM card used in a GSM mobile phone of a subscriber, wherein the SIM card in addition to a memory required for functions to make GSM services available, comprises a separate second memory for storing additional data, and a control unit (CPU) adapted for at least performing logical operations. The second memory has a preformatted file structure.

The invention further relates to a method for performing transactions by making use of the aforementioned architecture.

Techniques for performing payment transactions through mobile phone systems are known in the prior art. However, these proposals either provide a low level security with respect to verification of whether the action has been initiated by an authorized person, or significant technical changes of the system components are necessitated, e.g.: radical changes of the mobile phones or the accounting/auditing system of a bank.

The aim of the present invention is to provide an architecture and system which enables convenient and secure bank card payment through an existing mobile phone network when an electronic bill is presented. With the architecture and system according to the present invention safe payment is enabled in situations where use of a bank card is inconvenient or risky or is not possible at all, for example in case of paying the bills received from a utility company or paying the charge for mobile phone calls; buying at petrol stations, in restaurants, in other shops or through the Internet.

The essence of the invention can be summed up as follows:
the architecture according to the invention provides a transaction collecting channel included in the existing servicing environment of bank card payments;
the PKI based architecture according to the invention provides safe payment, where a SIM card represents the safety element on the client-side;
the architecture according to the invention comprises a virtual POS means for accomplishment of a POS-like bank card payment in a GSM and WEB environment;
in the system according to the invention the conventional SIM card is replaced by a multi-application intelligent card having SIM functions at the same time.

The architecture according to the invention supports electronic bill presentation and subsequent payment, except when a client (the card holder) initiates a transaction from the menu of his mobile phone in order to provide ballance for his prepaid GSM card. A common advantage of these accomplishments is that the card holder does not need to key in the data of the transaction for initiating a payment transaction, which may be a source of error, therefore it is more comfortable for the client.

Communication between participants is performed by means of SMSs. As a result of the applied cryptography each of the messages has a size of 1 SMS-block. The number of SMS-blocks used during a complete payment transaction depends on the particular business requirements of the transaction type; this number changes between 2 and 5.

The essence of this kind of service is that the customary, presently known bank card payment system is translated to an environment where transmission is performed through the GSM network, security is guaranteed by asymmetric cryptography, client identification is accomplished by means of a SIM card, and the pay terminal is represented by a virtual POS terminal in a mobile payment center.

In different business environments and situations different services are feasible. Here are a few examples of these services:
Top-up of a prepaid GSM card. A GSM client is able to fill up his own prepaid card by initiating a transaction from the menu of his mobile phone so that his bank account is immediately debited with a determined sum.
Settlement of a GSM (subscriber's) bill. The GSM client when receiving his bill presentation from his GSM provider settles his bill monthly by making use of his mobile bank card.
Paying utility bills. Upon receiving an electronic bill sent from a utility company at regular times, the client is able to settle the bill without paying in cash.
Web-shop. Secure buying through the Web is enabled, where control of the logistic functions is performed at the Web interface, payment is performed through a GSM device identified in the system, to an also identified object, that is, to a unit with a function of a transaction terminal, and keeping a bank account at one or more acquiring banks.
Buying from a catalogue. This may be done in like manner as buying through the Web. A secure way of paying without cash for articles chosen and ordered from catalogues, giant posters, etc.
Mobile paying in shops and restaurants. Similarly, it is a secure way to settle an account in these places.

In the system according to the invention the SIM card is provided with the following operational elements:
GSM application;
GSM service identification data;
application according to the invention;
individual SIM card identification (SIM ID or CSN);
cryptographic public key and private key.

The participants of the mobile bank card service are the clients of a bank (card holder) and the issuing bank. The client applies for a mobile bank card at registration. This can be done either personally at a bank, or, if the bank supports distant opening of an account and application for a bank card, then, for example when applying for a new SIM card, the client may receive the documents necessary for opening of an account and for handling in an application for the bank card at the customer service point of the GSM provider. The client fills in the registration form for a mobile bank card, then this form is forwarded to the bank in a secure manner well known and applied in the art. Then the bank generates an entirely virtual mobile “partner-card”, which is connected with the existing bank account of the client. Bank card and SIM card identification data connected to the mobile partner-card are transferred to a bank card data collecting means operated by the system in the bank. The bank card data collecting means generates the cryptogram for the mobile partner-card and subsequently to proper cryptographic steps, together with the SIM identification data, preferably through a bidirectional cryptographic interface transmits it to the payment center. The mobile payment center enters the mobile partner-card cryptogram onto the SIM card of the client. Upon completion of registration the device of the client is adapted to payment.

The system according to the invention comprises a number of subsystems which are separate from each other in terms of management and operation. These are the next:
SIM card preparation
Issuing payment instrument and management
Transaction and message processing
Cryptography
Telephone-side software
Archiving
CRM subsystem

A precondition of issuing payment instrument is that the user should have a SIM card containing the application according to the invention. Therefore, the client may go for example to the nearest point of sale of the GSM provider and hand in an application for the service. Then the client receives a (not yet activated, but registered in the system) SIM card having a preformatted file structure and containing the GSM application. Transactions may be performed by using various kinds of payment instruments, e.g.: bank card, bank account, etc. To initiate a transaction with a particular payment instrument, the payment instrument should be registered beforehand at the issuing institution, for example at the issuing bank, as a result of which the particular payment instrument is listed on the SIM card of the mobile phone.

When applying for a bank card or bank account based payment instrument, the client will see the issuing bank. If the client does not yet have an account, then opens one, however, if he already has an account, then—in case of a bank card type payment instrument—he may give an order for a mobile partner-card. When applying for a payment instrument, besides the usual data, the client must give information about his SIM card identifier (CSN) and the telephone number of his mobile phone.

In case of bank card based payment instrument the information system of the bank generates data for the client's mobile partner-card in a customary procedure, with the difference that creating an effective bank card is optional for the bank.

As a next step, the bank initiates transfer of data of the payment instrument towards the mobile payment center through an element of the system according to the invention, which element in this context constitutes a periphery of the same kind as the card-manufacturing machine.

A functional diagram of the system according to the invention will be described through an example by means of the attached drawing.

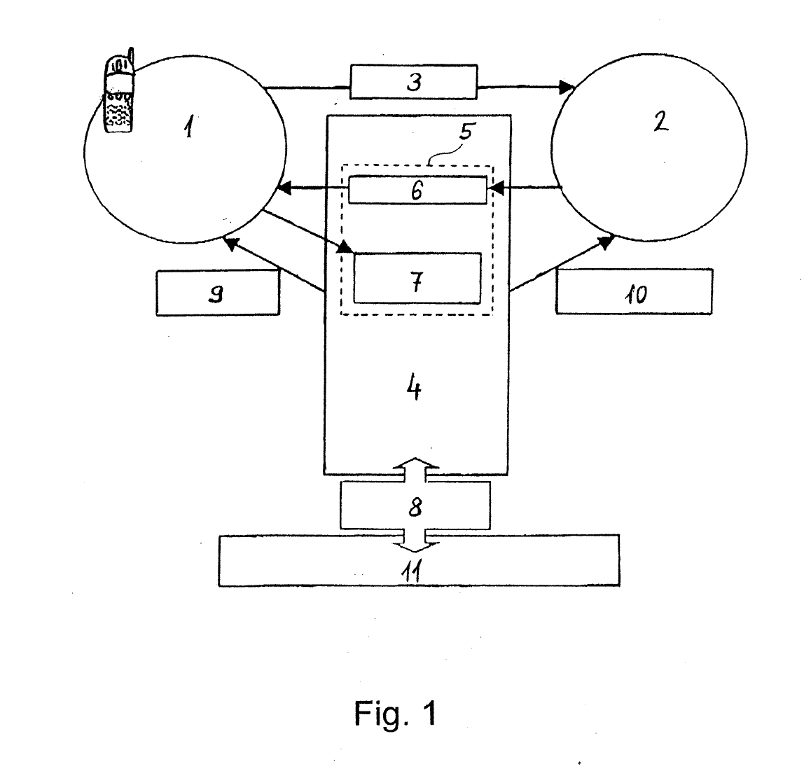

FIG. 1 shows the operational processes and the functional lay-out of the architecture.

In FIG. 1 service provider 2 enters the system as an owner of a virtual POS terminal 5. Virtual POS terminal 5 physically forms a marked electronic part, a storage domain of a mobile payment center 4. Each of the virtual POS terminals 5 in use must have an individual identifier, which, during an exchange of messages with client 1, appears as the name of the service and the service provider 2. Since the identifier may not contain only numerical values, it is preferable to do its selection similarly to doing a domain name registration. As with customary POS terminals, in case of operating a virtual POS terminal 5, an account kept in a bank must exist for receiving transfers. For this reason, upon opening an account, which in the customary way takes place in a bank, virtual POS terminal 5 identifier must be selected.

As a first step in the process of issuing and registering the mobile payment instrument, the future owner of the virtual POS terminal determines a name according to his wish, however, choosing a name is not a fundamental requirement. Service provider 2, for example a tradesman, may request the system to generate a virtual POS terminal identifier for him automatically. In either case, an attempt is made for selecting a “name” as identifier, since it may happen that the selected name has already been reserved. If the administrator of the bank attending to service provider 2 is in direct contact with mobile payment center 4 (e.g.: through the Internet), a check may be performed immediately through an interface of the mobile payment center set apart for this purpose in order to determine whether the name is reserved or not. If it is not possible, then the tradesman obtains information about the status of the name he selected for the virtual POS terminal later, through the bank. When the attempt for selecting a name is successful, then this selected name is considered by the system as reserved for a period of time determined collectively by the bank and the tradesman, and requests for the same name originating from other sources are rejected. Reservation ceases to exist when the determined period of time expires, or it becomes definitive when request of the client for operating a virtual POS terminal is approved by the bank.

For functioning of service provider 2 the following data are needed:
Virtual POS terminal identifier
One or more TID identifiers (virtual POS terminal identifiers) depending on the load
Bill number of service provider 2 for transactions of a transfer type
Data relating to communication channels through which transaction acknowledgements (E-Slip) are transmitted
Restrictions relating to payment instrument selectable by the users

TID identifiers are needed for bank card based transaction authorization which may be executed for example through a known protocol BASE24. A TID identifier is issued by a bank card authorization center 11. It is possible for service provider 2 claiming for a virtual POS terminal 5 to make a request for more TIDs for the same virtual POS terminal 5. Load on a virtual POS terminal may be decreased by initiating parallel transfers using different TIDs, the maximal number of transfers depends on the number of channels granted by the bank card authorization center 11.

Through restrictions relating to payment instrument service provider 2 may clearly determine which type of payment instrument of which issuing institution (bank) he is ready to accept. Several categories relative to payment instrument may be determined, which upon presenting the bill makes selection of other restrictions (categories) per client possible.

In case of big service providers initiation of registration may be completed on paper. When telephone holders are considered as potential service providers 2 in the system according to the invention, then virtual POS terminal registration should be automatized, for this an Internet based interface may be used.

For forwarding the registrations of mobile bank cards and virtual POS terminals towards the mobile payment center, it is essential to install a work station as a part of the system according to the invention, which is connected to the system responsible for processing of banking demands (payment instrument, virtual POS terminal). This computer is physically connected to the computer network of the bank, however, access to the network for the work station is not needed. Preferably, the work station comprises a chip card reading unit, a key card and a communication unit which guarantees communication of data with a central unit according to the invention.

Information system of the bank makes demands for payment instrument and virtual POS terminals according to the invention accessible in a shared directory of the work station. Exchange of data is executed through text files having a determined format (a file structure comprising own control codes). Demands for mobile cards and virtual POS terminals are placed into the same input directory. The time of generating a file and the number of records in the directory are determined by the number of accumulated demands and the date of the earliest demand. Scheduling of data transfer through files is a duty of the bank.

Components (presenting individual registration types, e.g.: payment instrument, virtual POS terminal) running in mobile payment center 4 control the bank's input directory from time to time and compare it to the file catalogue recorded in the system, and when new records are found, process of these files are initiated. As a first step of this process, the component decodes the file by making use of the private key of the mobile payment center, then the bank's public key of the mobile payment center, and after that, depending on the type of registration, the component transmits the file to the respective processing component.

Generation of response files to be transmitted to the bank is a task for the component which is responsible for acknowledgement of registrations later ending without success.

If there is no registration for the SIM card, then the given SIM card is activated in the system, and the phone number obtained from the GSM phone number issuer 3 according to FIG. 1 is saved. In case of successfully registered SIM card, the forwarded phone number is compared to the phone number presently registered in the system, and when there is a disagreement, an error message is sent to the bank's acknowledgement buffer. Upon a successful SIM card activation the component performing registration of the payment instrument for the bank, generates a registration message, and, addressed to the phone number belonging to the SIM card, transmits it to the message request server component. The component which performs processing of requests for bank cards keeps a record of the individual operations, and the file, into which the individual registrations for payment instrument arrive, can be identified by make use of these records. This registration is mainly needed for archiving and data retrieval from archives. Responses to messages arriving from the user's phone in relation to registration of payment instrument are evaluated by the relative component of the message processor.

The process of registration means activation of a virtual POS terminal identifier in the system according to the invention and execution of subsequent verifications needed for managing of a bank's POS, as well as activation of keys belonging to TIDs, in each case. Information relating to success or failure in activation of a virtual POS terminal is contained in a response file. After all POS terminal records of the source file have been processed and simultaneously with this results of the recordings are available, the response file is placed into a directory of the mobile payment center 4 containing bank acknowledgements.

The component which transmits acknowledgements running within mobile payment center 4 is responsible for generating acknowledgement files for unsuccessful registrations relative to payment instrument and for copying them into the bank's output directory. Accidental false demands for payment instrument are temporarily stored in the bank acknowledgement buffer. A process performed from time to time ensures that an acknowledgement file is generated for these unsuccessful registration attempts being in the buffer. Then, the aforementioned acknowledgement files relative to registration of a payment instrument as well as a virtual POS terminal are coded by making use of the private key of the mobile payment center 4, the public key of the bank, and transmitted to the bank by the component.

The transmitted files are taken into a directory of the mobile payment center 4 shared for response files. Acknowledgement transmitting component running in mobile payment center 4 decodes the newly arrived files and moves them to a directory shared for the bank's information system.

Transaction processing—logically and in terms of dependence on external resources—consists of several separate actions. Modules (components) performing the individual actions are applications which may run independently. The individual modules communicate each other through asynchronous waiting queues, in this way they may operate independent of availability of other modules. Components (modules) operate on application servers in a component running environment, through which new component replications may be initiated or connection to an already running module replication is enabled through connectors. A system of frames co-ordinates the modules participating in transaction processing, keeps record of application servers and module replications running on these servers.

Through the system of frames tracing of processes running on module replications is enabled by making use of individual status tables featuring the individual modules. Through the message register information may be obtained about events of great importance taking place in the module replications. Module replications send the messages to the system of frames through a uniform message sender component. Each of the events has an individual message code and category designation within the whole system. Filters may be used for filtering individual message codes and categories. By making use of the waiting queues status tables, capacity and changes of the capacity are traceable.

The outlined operations make precise keeping track of all of the substantial process being performed in the system possible. Automatism and alerts based on them enable rapid response to unexpected events. Response may be effected on application level in a predictable case, and in an unexpected case it is effected by the administrators.

The SMS communication layer controls receiving or sending of packets according to the direction of message packets travelling in data channels. There are different data channels reserved for data moving in and out respectively. According to the direction of data-travel different components are used by the system.

Incoming data are filtered by a blacklist filter, and the messages arriving from source addresses which are found definitely disabled, are discarded at once. Messages arriving from sources which are temporarily designated for blacklist, are put in a separate error register with the source marked; the content of the register may be analyzed later. A routine counts the erroneous packets arriving from the same source, and when the number of these packets exceeds a threshold value, the sending source is definitely entered on the blacklist.

The blacklist filtered (still coded) raw message packet together with the respective data—e.g.: the individual message identifier—is sent to the incoming messages buffer. On the one hand, the primary function of the message buffer positioned behind the communication layer is to make the communication subsystem independent from being available to other components of the system, on the other hand, it makes parallel processing simpler.

Subsequent to encryption, messages to be sent to users, together with data assisting in communication and registration respectively are transmitted to the outgoing data buffer. Components which are responsible for transmission of messages remove the packets sent to the data channel handled by them one after the other from the outgoing data buffer, then the already prepared message is forwarded to the destination address by mobile payment center 4.

A task for an SMS communication module may be to make connection with the SMS center of the mobile payment center 4 and service provider 2 and to forward and receive transactions to and from the center respectively. The mobile payment center 4 substantially consists of a plurality of virtual POS terminals 5, which are located physically separate from client 1, service provider 2, GSM service provider and issuing/acquiring banks.

Messages arriving at mobile payment center 4 are decoded on the basis of keys determined by the SIM identifier. Messages restored in their original form are converted according to the contained type and the fields are passed on to the processor components. The message processor may request the messages running in several replications from the input buffer. Each of the messages describes one operation. Types of messages arriving at the mobile payment center and processor components representing the message are as follows:
payment instrument registration acknowledgement
acknowledgement of activation and deactivation of application
order for payment, refusal complaint, acceptance (in case of bill presentation)
initiation of sending a bill presentation to another phone in the system.

The order of payment preparatory component, after a control of the form and possibly the content of the message fields, inserts data in transaction buffer 7 containing transactions. The transaction types whose structure is different from each other to some extent are handled together. Depending on the result of the transaction preparation an answer message is created, which is transmitted to the outgoing message buffer, addressed to the sender source. The answer message may be an error message (if the message failed during control of the content) or an interim acknowledgement (in case of delayed transaction).

In case of initiation of sending a bill presentation depending on the status of the target telephone in the system an error message is transmitted to the initiator, or a bill presentation is transmitted to the receiver. This bill presentation formally equals to bill presentations otherwise initiated on server side and has the same features.

The individual types of messages are different from each other as regards their function and structure. The structure of the types of messages is determined in the structure description table. The messages are marked by a type identifier, on the basis of which processing on the receiver side is able to identify the structure (sequence, length and type) of the fields of the message from the structure description table.

In case of a 1024 bit key RSA asymmetric encryption algorithm the cryptogram generated with the employed encryption method has a size of 128 bytes. The maximal size of a packet through an SMS based communication channel is 140 bytes.

When processing a transaction, transaction buffer 7 stores transaction requests which arrived in the system and are prepared by the message processor. The buffer administrator requests transactions with the appropriate status from transaction buffer 7. Buffer administrator manages waiting queues, numbers the transaction requests, monitors the expiry of delayed transactions, re-schedules the transaction in case of an unsuccessful attempt and registers the number of tries. Each transaction request contains the date of expiration, which with certain types of transactions may be determined by the service provider, otherwise it equals with the date of registration of the transaction. In case of an unsuccessful transaction processing the buffer administrator may be requested to replace the transaction request into the waiting queue by performing a count shift, so that the serial number of the request buffer will get a value which is the sum of the greatest serial number which has not yet been allocated plus the shift. Upon repeated replacement of a transaction request the buffer administrator automatically increases the number of the attempts made for processing of the registration. The buffer administrator informs the processor about the number of the unsuccessful attempts as a result of which the transaction request may be declared definitely erroneous.

The channel administrator scheduling the initiations of transactions always requests a transaction for a disengaged channel type. The buffer administrator must take into consideration what type of payment instrument may be used for transfer through the free channel type, and select a transaction request from transaction buffer 7 according to this consideration.

Further, in case of bank card based payment instrument it must be determined whether a free (momentarily not used in parallel transfers) TID exists among the ones allocated to the virtual POS terminal 5 involved in the transaction. In case of successful transaction selection, the buffer administrator must reserve the request, or in case of a bank card the TID in question.

Upon accomplishment of the transfer the processor requests the removal of the transaction from the transaction buffer 7, in this manner the reserved TID becomes free.

Execution of a transaction request through the authorization center(s) of the bank constitutes the bottleneck in the whole transaction processing. A transaction with the authorization center may be effectuated through number of communication channels at the same time. Communication channels can be classified according to the applied communication protocol and the admitted payment instrument (bank card, bill number, etc.). In order to perform an optimal transaction processing, with considering the bottleneck in the communication through the authorization centers, scheduling of the processing is determined by the available data channels. Scheduling of the processes is performed by the channel administrator. As a result of the disengagement of a certain type of channel a request is transmitted to the buffer administrator for a subsequent transaction in compliance with that type of channel. If no transaction applicable to processing is received from the buffer administrator, then a transaction is requested for the next channel in the list of free channels. If the end of the list is reached, selection of the channels is recommenced, in this way it is ensured that each channel type is provided with transactions approximately with the same frequency.

After a successful transaction request the transaction together with the data received from the buffer administrator are transmitted to the transaction processing component representing the given channel. After transmission of data, the channel administrator immediately receives control back, in this manner it may continue examination of the free channels.

A transaction request is performed by the transaction processing component through a communication channel personalized by this component. The task of the transaction processing component is to analyze the result of the transfer, and is liable to instruct the buffer administrator to perform further steps depending on the result of the transfer, that is, to remove transaction request from the waiting queue if the operation was successful, to delay the request (serial number shift) in case of communication error, and to declare the transaction request invalid in case of an unmanageable error. As a result of a successful transaction the processing component generates so called E-Slips 9, 10, which are transmitted to the outgoing message buffer addressed to the user and also to the operator of the virtual POS terminal. After generation of the E-Slip 9, 10 the transaction processing component sends a notification to the channel administrator indicating that the represented channels is free again. Processing of transaction requests run parallel (on different lines), in accordance with the number of communication channels in the system.

The component performing the transfer obtains transaction data, TID and the number of the communication channel as parameters.

In the system according to the invention each of the acquiring persons (tradesman) are provided with a virtual POS terminal identifier. This virtual POS terminal identifier is provided with at least one terminal identifier (TID), which is registered in the system of the bank card authorization center 11. Depending on the load, a virtual POS terminal 5 may have a number of TIDs. Transactions arriving at service providers 2 are authorized through the TID. When registering a given virtual POS, similarly to a “normal” POS, transaction authentication keys of the TID are downloaded through the bank connection (leased line, switched line modem).

Virtual POS terminal 5 obtains card data, the total amount of purchase and the TID of service provider 2 from the system according to the invention. Virtual POS terminal 5 examines card data and expiration. If one of them precludes purchase, then the transaction is rejected, otherwise a transaction is formed from the above data which is forwarded to the authorization center 11. If the authorization center accepts the forwarded transaction, then sends a notification about acceptance to the system according to the invention, otherwise rejects the requested transaction.

Reminders sent to telephones will take the place of conventional postal-orders, printed money orders in the system for settlement of an electronic bill. Upon settlement of the electronic bill, the sum to be deducted from the account of client 1 is credited to the account of the reminder sender service provider 2 (for example a water/gas/power supplier).

Service provider 2 initiates a reminder towards the telephone number of client 1 having a subscription according to the invention. The reminder briefly contains the cause of demand, the due date of payment and the sum to be paid, and with these it is sent to mobile payment center 4. Based on preliminary agreement between service provider 2 and mobile payment center 4 service provider 2 may select the type of the payment instrument to be used by the client for settling the bill.

The cryptographic element used in the system ensures proper cryptographic protection for data flowing in the system.

Preferably, the selected algorithm is the known RSA algorithm with a key length of 1024 bits. RSA algorithm uses a public key and a private key for encryption. Messages coded with a private key can be read only with a public key, and messages coded with a public key can be read only with a private key. In this case any person who knows the public key may send a message to the owner of the private key. The authenticity of the sender can not be guaranteed in this case. The dual key is needed to solve this problem of authentication. The sender party codes the message with his own private key, then codes the so coded message with the public key of the receiving party. In this case the message can be unpacked only by the receiving party, by using his own private key first, then the public key of the sender. In this manner the problem of authenticity is solved.

The above described embodiments, particularities, programming and concretized computing methods merely serve as examples. Modifications and alternative embodiments can be made without departing from the scope of the present invention as defined in the appended claims.

1. Architecture of simplified hardware requirements for bank card payment transactions in a large group of clients, in which clients (1) and service providers (2) exist, the clients keep a bank account at one or more issuing banks which are authorized to issue bank cards, and have a mobile bank card provided with a customary bank card identification information, a GSM mobile phone, and a valid SIM card for enabling access of the GSM services, the service providers keep a bank account at one or more acquiring banks, and have a unit with a function of a transaction terminal, and a device adapted for receiving system messages, characterized in that said client (1) is provided with an extended function SIM card which comprises payment application and customary bank card identification information, said architecture comprises a mobile payment center (4) which is connected to the client and the service provider of an actual transaction through a bidirectional cryptographic interface and a communication channel of a first type provided by said GSM service provider, and is connected to bank card authorization center (s) (11) of an actual acquiring bank involved in said transaction through a bidirectional cryptographic interface and a communication channel of a second type, said mobile payment center (4) comprises at least one virtual POS terminal (5) as a transaction terminal unit for each service provider (2), said virtual POS terminal (5) is adapted to at least control data handled by POS terminals with conventional hardware which are used as transaction terminal units for reading bank cards, and/or to handle authorization message answer through communication channel of the second type.

2. Architecture according to claim 1 characterized in that said cryptographic interface uses asymmetric cryptography working with public and private keys.

3. Architecture according to claim 1 characterized in that said communication channel of the first type is applicable for SMS based message exchange.

4. Architecture according to claim 3 characterized in that said bidirectional cryptographic interface is integrated in the SIM card.

5. Architecture according to claim 4 characterized in that said SMS message prior to encryption preceding said bidirectional cryptographic interface is inaccessible at user level.

6. Architecture according to claim 1 characterized in that said communication channel of the second type is a wire channel.

7. Architecture according to claim 1 characterized in that said service provider (2) is a GSM service provider, and said transaction is a prepaid account balance top-up.

8-11. (canceled)

12. Extended function SIM card for a GSM mobile telephone of a subscriber, which in addition to a memory required for functions to make GSM services available, comprises a separate second memory for storing additional data, and a control unit (CPU) adapted for at least performing logical operations characterized in that the second memory is adapted to store at least all of the bank card information customarily needed, and further, said extended function SIM card comprises a bidirectional cryptographic interface separated from the GSM major function.

13. Method for personalization of an extended function SIM card used in a GSM mobile telephone of a subscriber, wherein the SIM card in addition to a memory required for functions to make GSM services available, comprises a separate second memory for storing additional data, and a control unit (CPU) adapted for at least performing logical operations, the second memory has a preformatted file structure, characterized in that an extended function SIM card activated by a GSM service provider earlier, is provided with bank card information in said second memory, said information is encrypted through a cryptographic interface in a mobile payment center (4) which is separate from said GSM service provider.

14. Method for performing transactions by making use of the architecture according to claim 1 in which a client (1) initiates a payment transaction characterized in that said client (1) initiates said payment transaction from a subscribed GSM mobile telephone having an activated and personalized extended function SIM card, upon initiation an asymmetric cryptography coded SMS message is transmitted to a mobile payment center (4) where an authorization message is generated in a known manner on a virtual POS terminal (5), said message is transmitted to a bank card authorization system, and a similarly coded SMS based message about the result of authorization is sent back to the subscribed GSM mobile telephone of said client (1) and to said service provider (2).

15. Method for performing transactions by making use of the architecture according to claim 20 in which a service provider (2) initiates a payment transaction on the basis of an agreement brought about between said service provider (2) and a client (1), characterized in that an asymmetric cryptography coded SMS based message for initiation of a payment transaction is transmitted to a subscribed GSM mobile telephone of said client (1) through a mobile payment center (4), then, in case of said client's approval of the displayed message and the payment transaction another asymmetric cryptography coded SMS based message is transmitted from said subscribed GSM mobile telephone of said client (1) to said mobile payment center (4), where debit and credit operations are initiated with issuing banks and acquiring banks involved in said transaction through a communication channel of the second type by means of a message exchange effectuated in a manner known with hardware POS terminals, and an asymmetric cryptography coded SMS based electronic receipt, a so called E-slip (10) relating to the completion of said transaction is sent to a subscribed GSM mobile telephone of said service provider (2).

16. Method for performing transactions by making use of the architecture according to claim 1 in which a client (1) initiates a payment transaction characterized in that said client (1) initiates a message for purchase from a subscribed GSM mobile telephone having an activated and personalized extended function SIM card, upon initiation an asymmetric cryptography coded SMS message is transmitted to a mobile payment center (4), said message is transmitted to a service provider (2) explicitly identified in said message through a communication channel of a second type, and said service provider (2) brings about an agreement through a communication channel of a third type with the client (1) explicitly identified in said purchase initiating message, on the basis of which said service provider (2) initiates a payment transaction, and said transaction initiating asymmetric cryptography coded SMS based message is transmitted to a subscribed GSM mobile telephone of said client (1) through said mobile payment center (4), then, in case of said client's approval of the displayed message and the payment transaction another asymmetric cryptography coded SMS based message is transmitted from said subscribed GSM mobile telephone of said client (1) to said mobile payment center (4), where debit and credit operations are initiated with issuing banks and acquiring banks involved in said transaction through a communication channel of the second type by means of a message exchange effectuated in a manner known with hardware POS terminals, and an asymmetric cryptography coded SMS based electronic receipt, a so called E-slip (10) relating to the completion of said transaction is sent to a subscribed GSM mobile telephone of said service provider (2).

17. Method according to claim 14 characterized in that said SMS based message exchange and said message exchange effectuated through communication channel of the second type are separated from each other in time.

18. Method according to claim 14 characterized in that arbitrary electronic payment instrument is used as bank card.

19. (canceled)
